(19) United States
(12) Patent Application Publication
(10) Pub. No.: US 2011/0321104 A1
(43) Pub. Date: Dec. 29, 2011

(54) SYSTEM AND METHOD FOR MASS DISTRIBUTION OF HIGH QUALITY VIDEO

(75) Inventors: Gregory K. Lancaster, Calgary (CA); Matt Sherwood, Okotoks (CA); Danny D. Lowe, Calgary (CA)

(73) Assignee: Worldplay (Barbados) Inc., Bridgetown (BB)

(21) Appl. No.: 12/822,912

(22) Filed: Jun. 24, 2010

(51) Int. Cl. H04N 7/173; H04N 5/44; H04N 7/18

(52) U.S. Cl. 725/98; 725/118; 348/159; 725/131; 348/734; 348/E05.096; 348/E07.085

(57) ABSTRACT

Systems and methods of compressing source video to 3 MBits/sec and under (deep compression), making it is possible to distribute a wide range of movies, sports and other action laden videos simultaneously to a wide number of viewers. In one embodiment, deeply compressed video distribution is delivered on demand to requesting viewers via an addressable network.

### CROSS-REFERENCE TO RELATED APPLICATIONS

This application is related to commonly owned U.S. patent application Ser. No. 12/176,374, filed on Jul. 19, 2008 and entitled “SYSTEMS AND METHODS FOR HIGHLY EFFICIENT VIDEO COMPRESSION USING SELECTIVE RETENTION OF RELEVANT VISUAL DETAIL,” U.S. patent application Ser. No. 12/333,708, filed on Dec. 12, 2008 and entitled “SYSTEMS AND METHODS FOR DEBLOCKING SEQUENTIAL IMAGES BY DETERMINING PIXEL INTENSITIES BASED ON LOCAL STATISTICAL MEASURES,” U.S. patent application Ser. No. 12/638,703, filed on Dec. 15, 2009 and entitled “VIDEO DECODER,” and concurrently filed, co-pending, commonly owned U.S. patent application Ser. No. ______, Attorney Docket No. 54729/P016US/11000746, entitled “SYSTEMS AND METHODS FOR HIGHLY EFFICIENT COMPRESSION OF VIDEO,” U.S. patent application Ser. No. ______, Attorney Docket No. 54729/P017US/11000747, entitled “A METHOD FOR DOWNSAMPLING IMAGES,” U.S. patent application Ser. No. ______, Attorney Docket No. 54729/P018US/11000748, entitled “DECODER FOR MULTIPLE INDEPENDENT VIDEO STREAM DECODING,” U.S. patent application Ser. No. ______, Attorney Docket No. 54729/P019US/11000749, entitled “SYSTEMS AND METHODS FOR CONTROLLING THE TRANSMISSION OF INDEPENDENT BUT TEMPORALLY RELATED ELEMENTARY VIDEO STREAMS,” and U.S. patent application Ser. No. ______, Attorney Docket No. 54729/P020US/11000750, entitled “SYSTEMS AND METHODS FOR ADAPTING VIDEO DATA TRANSMISSIONS TO COMMUNICATION NETWORK BANDWIDTH VARIATIONS.” All of the above-referenced applications are hereby incorporated by reference herein.

### TECHNICAL FIELD

This disclosure relates to distribution of high definition video and more specifically to systems and methods for distribution of high quality video using relatively low bandwidth.

### BACKGROUND OF THE INVENTION

Currently, the predominate method of video (video program) distribution to the consumer market is via satellite or cable, each of which has bandwidth limitations at least at the consumer end of the communication transmission pipeline. Video programs originate from various sources such as sporting events, concerts, musical events, plays, movies and news. In the case of cable, the cable operators must stream many channels of information over a cable having a finite total bandwidth. This bandwidth must then be allocated to each channel since all the channels must carry all of the current programming. High definition video images as originally created contain a high pixel count and even with compression require a bandwidth of between 6 to 10 MBits/sec (depending upon which analysis one relies on) to transmit (or record). While cable is theoretically capable of carrying video at 30 MBits/sec, that rate for all cable channels on the cable is not practical. Typically, the cable delivers on average between 1 and 3 MBits/sec/channel. This is far below the 10 MBits/sec now required for high fidelity video viewing. High fidelity is defined as the viewed reconstructed images being perceived by the human visual system (HVS) as a close representation of the source image. Thus, in high fidelity situations the viewer of the decoded (decompressed) video image does not discern differences (or objectionable differences) from the original source image.

Current systems that attempt to compress video below 10 Mbits/sec have problems, especially when the video contains high motion (or scene changing) content. This is so because in order to achieve compression not all of the source video is transmitted. When scenes change, or when movement occurs, the loss of pixel data due to the compression causes the reconstructed image to contain artifacts (portions of the video that disturb the viewer's visual system). These artifacts make the resulting image noticeably inferior to the original source images. Thus, while several attempts have been made to distribute a wide variety of HD quality images to viewers, bandwidth problems have severely limited any such distribution, and the distribution that exists suffers from inferior viewer satisfaction.

### BRIEF SUMMARY OF THE INVENTION

By compressing source video to 3 MBits/sec and under (deep compression), it is possible to distribute a wide range of movies, sports and other action-laden videos simultaneously to a wide number of viewers. In one embodiment, deeply compressed video distribution is delivered on demand to requesting viewers via an addressable network.

In one embodiment, the source video is gathered live from an event and delivered to a network distribution point via deep compression and then, in combination with deeply compressed video from other gathering points, a large number of videos are available to requesting viewers upon demand. In one embodiment, some, or all, of the source videos are stored for a period of time and made available to viewers upon demand of each viewer even when the event from which the video was made is completed.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 shows one embodiment of a system for allowing a plurality of displays to concurrently access a plurality of video sources without sacrificing video fidelity;

FIG. 2 shows one embodiment of a compression system for reducing the bandwidth requirements of a source video;

FIG. 3 shows one embodiment of a network interface for allowing content from the Internet to be presented on a TV screen;

FIG. 4 shows one example of a file structure for controlling customer delivery options; and

FIG. 5 shows one embodiment of a method of operation of the systems disclosed herein.

### DETAILED DESCRIPTION OF THE INVENTION

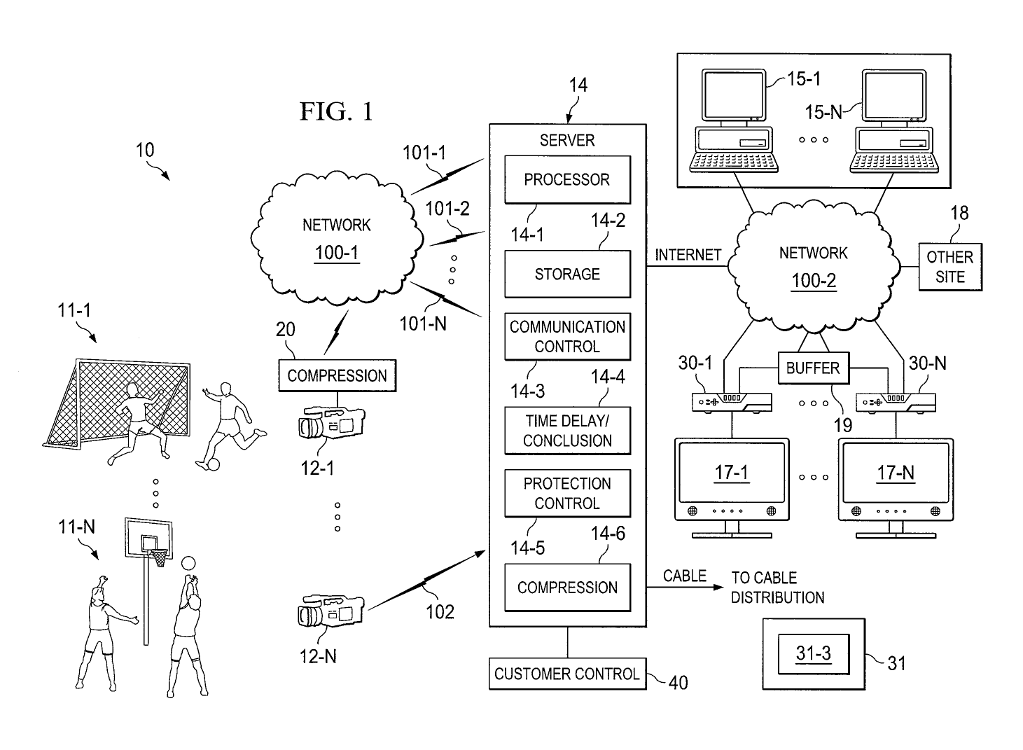

FIG. 1 shows one embodiment 10 of a system for allowing a plurality of displays, such as displays 15-1 to 15-N and 17-1 to 17-N, to concurrently access a plurality of video sources, such as sources 12-1 to 12-N, without sacrificing video fidelity. In the embodiment illustrated, sporting events, such as soccer 11-1 is captured by one or more cameras 12-1 as a high quality source image. Today, this high quality would likely be HD video most commonly having display resolutions of 1280×720 pixels (720p) or 1920×1080 pixels (1080i/1080p), but the concepts discussed herein apply equally to any video stream requiring a bandwidth of greater than 3 Mbits/sec for transmission. The bandwidth required for transmitting video depends on the compression method being used, the nature of the video (e.g., static/simple vs. chaotic/complex), and the desired visual fidelity. Very often the desired visual fidelity will allow for visible artifacts, as long as they are acceptable to the user (i.e., often high fidelity video is discernable from the original source). In general, the compression process discussed herein allows ‘typical’ HD Video to be compressed and decoded with acceptable visual fidelity at bitrates below 3 Mbps (and often below 1.5 Mbps) when conventional compression methods like H.264 produce artifacts resulting in unacceptable visual fidelity.

It is necessary to deliver the source image to one or more central locations, such as to server 14, for ultimate controlled distribution to end users. One system for delivering the source data to server 14 is the method used today for many sporting events which involves capturing the images from the event, such as from basketball event 11-N, via one or more cameras, such as camera 12-N, and transporting the image from the camera(s) to the server via a high bandwidth connection 102 which could involve satellite or microwave relay. Compression may or may not be used on this link. End users at displays 15-1 to 15-N and 17-1 to 17-N may request over network 100-1, particular ones of events 11-1 to 11-N that are captured by one or more cameras 12-1 as a high quality source image. The request sent by the endusers for the high quality source image may, among other things, identify a specific video program deliverable to an associated network address. In cases where the event is being captured by a plurality of cameras, the request may specify which of the plurality of cameras should be the source feed.

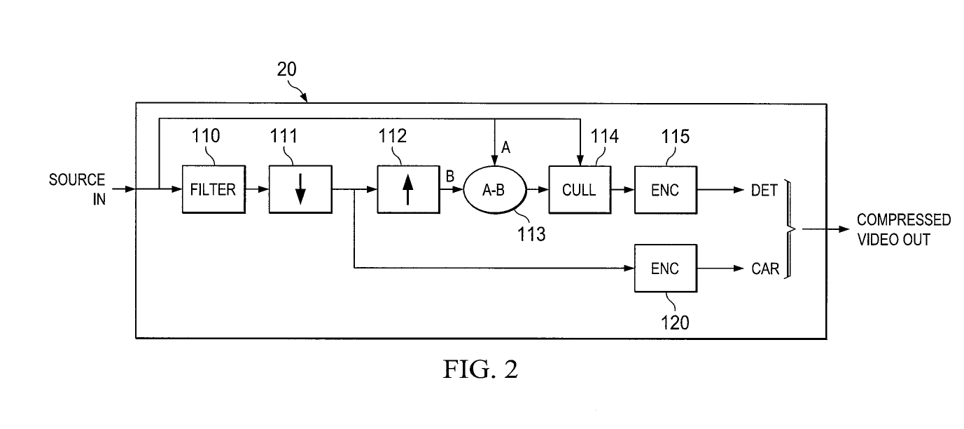

In situations where it is practical, the source data can be compressed down to a desirable transmission rate by compression device 20 (as will be discussed with respect to FIG. 2) and delivered to server 14 (or any number of other distribution points) via network 100-1. In one embodiment, the transmission path via network 100-1 can be the Internet. While a single camera is shown at each sporting event it is understood that multiple cameras can be employed and their raw images sent back (up-link) to the distribution point or a pre-production selection of camera shots can be decided upon at the various locations and a single image up-linked for further distribution. When using high bandwidth for the up-link transmission it is usually advantageous to select the desirable camera angles local to the event. However, if high compression is used (under 3 MBits/sec) then it might be advantageous to send the raw feeds from all the cameras back to a remote processing facility, for example, using the Internet and do the production control via element 14-5. Alternatively, the feed may be sent directly to an end user without being edited. Delivery to the end user may involve compressing the video captured by the camera at the camera, at a server remote from the cameras or both at the camera and at the server.

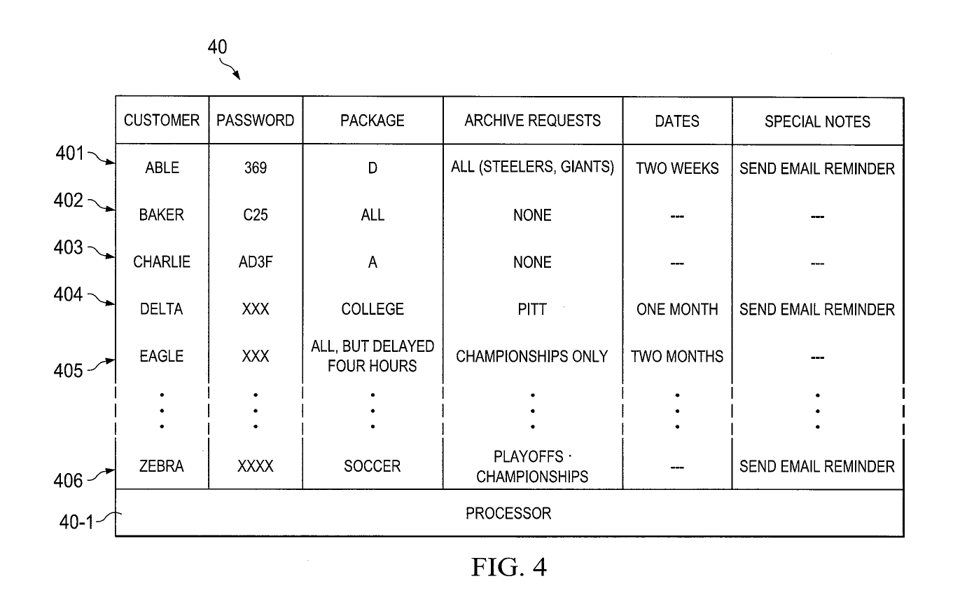

Once the final video stream is prepared, either local to the event or via production control 14-5 at a remote location, the final video stream can be, if desired, stored in storage 14-2 under control of processor 14-1. Communication control 14-3, working in cooperation with customer control 40 and processor 40-1 (shown in FIG. 4), makes the video available to as many end users as are currently requesting a particular video.

The delivery of the selected video stream can be by Internet (addressed network) connection or by cable distribution. If by Internet then network 100-2 (which can be the same or different from network 100-1) can be used. If the original source video had not already been compressed to the desirable transmission rate then compression 14-6 (the same as compression 20, but with perhaps more stringent parameters) can be used to further compress the video stream down to the 1-3 MBits/sec desired for end user delivery.

At the user's end, the selected video is delivered to either a PC, such as PCs 15-1 to 15-N, or to TVs, such as TVs 17-1 to 17-N. In some cases the decoding of the compressed video stream will be accomplished within the PC or it can be performed external thereto with a decoder. For TV viewing a set top box (decoder), such as decoders 30-1 to 30-N are used to recover the compressed (encoded) video. In some situations, the set top box will be integrated into the TV.

FIG. 2 shows one embodiment 20 of a compression system for reducing the bandwidth requirements of a source video. The source video (src) is filtered (110) to remove high frequency image components such that upon subsequent downsampling to a lower resolution (111) the resulting image has minimal aliasing artifacts.

The downsampled video ('clean carrier') produced by (111) is then upsampled to the same resolution as the original source video by (112). As discussed above, the upsampling method used here must match the upsampling method to be used later when decoding the final delivered compressed video.

The upsampled video from (112) is then subtracted (113) from the original source video to produce a ‘clean detail’ video stream. This video stream contains only the high-frequency video components of the original source video that are not represented in the clean carrier.

The clean detail video is ‘culled’ (114) to remove image elements which would be imperceptible or irrelevant at the desired target quality of the final delivered video. For example, finely-detailed image components that are moving erratically would typically not be perceived by the human visual system (HVS), and would be removed by the culling process (114-3).

The culled detail video is encoded/compressed by (115) to produce the detail video stream for delivery (‘delivered detail’). The downsampled video stream is then compressed (encoded) (120-3) to produce the final carrier stream to be delivered (the ‘delivered carrier’).

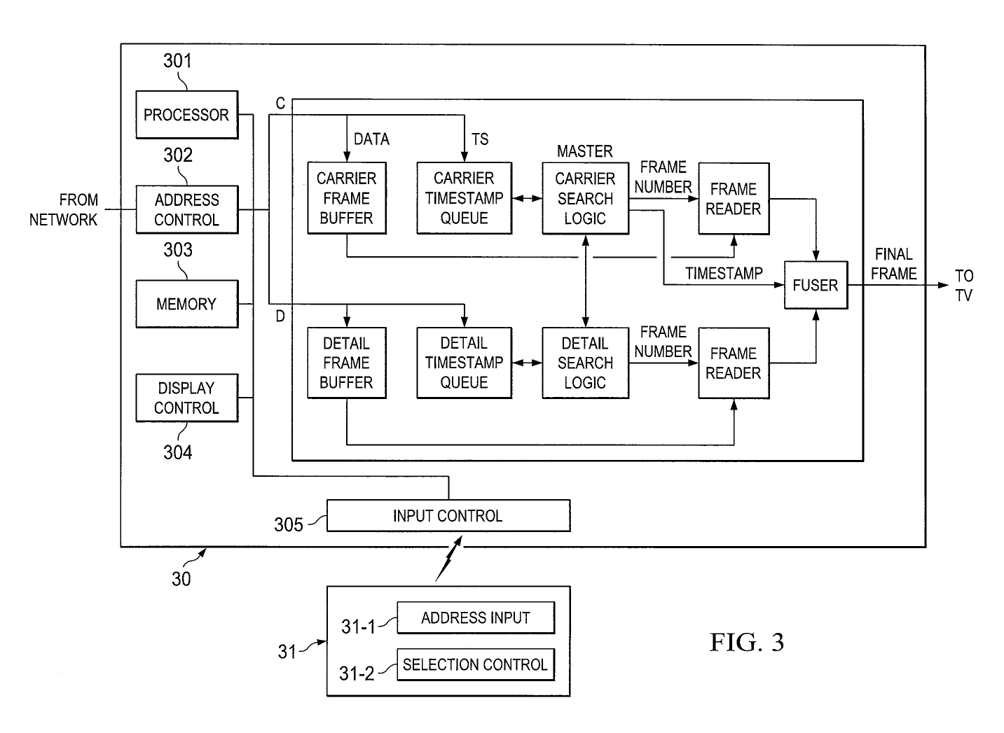

FIG. 3 shows one embodiment 30 of a network interface (set top box) for allowing content from the Internet, (or from a cable) to be presented on a TV screen, such as on TV 17-1. Processor 301 controls the operation of interface 30 (shown as 30-1 and 30-N in FIG. 1). Interface 30 is a decoder (decompressor) for recovering the compressed video stream as it arrives from the network. When the Internet is used for content delivery, then address control 302 operates to communicate with the video source distributor which, in this example, is server 14, FIG. 1. In some situations, the user, via remote device (clicker) 31 selects the program desired and address control 302, working in cooperation with remote device 31, sends the desired information to the server in order to instruct the server to send a desired video stream to the user's interface (30-1 in FIG. 1). In some cases the instructions will be maintained in memory 303 and selected by the user or controlled without user involvement to obtain a given program at a particular time. Display control 304 allows remote 31, operating in conjunction with memory 303, processor 301 and address control 302, to display for the user the programming and control sequences.

Remote 31 contains, for example, address input 31-1 which can be a keypad, a touch screen or a combination thereof. Program selection control 31-2 can share address input or can be separate therefrom. Note that in a typical situation the user would log on to a site, say server 14, and by using a passcode or other validation device, become validated to receive certain programs. This validation can be automatic under control of address control 302 such that server 14 recognizes the user via an electronic handshake or a token or passcode passed from the customer's device. When the user is viewing from a different device not previously known to server 14 as being associated with a particular user, then the user can input a validation passcode(s). This validation passcode can be good for a period of time, if desired.

In some embodiments of the invention a set top box may include decompressor 30. The set top box may have the capability of receiving and decompressing, concurrently, a plurality of video feeds from different cameras capturing an event. These video feeds may be the raw (unedited) video feeds from the cameras. Further, the set top box may be configured to control the concurrent display, at a user device, of a plurality of the video feeds as a function of instructions from a user. For example, the user may have one sporting event on majority of the screen and a second sporting event inserted in a smaller portion of the screen. The user may provide these instructions via a clicker device, such as remote 31, which is remote from the set top box and operable by the user. Remote 31 may have editing application 31-3 that allows the user to edit and control the raw video feeds. Buffer 19 may be used to store the raw video feeds so that they may be edited and/or controlled by the user with the use of application 31-3.

FIG. 4 shows one example of a file structure 40 for controlling customer delivery options. In one embodiment, each customer has a profile of available programs. For convenience these profiles can be thought of as packages such that user Able (line 401) is eligible for package D, which may be Dallas Cowboys plus two other teams. User Able has requested (perhaps for an additional fee) to have all games achieved for two weeks. This means that user Able can log on to server 14 at any time within two weeks of when any Cowboys, Steelers or Giants game has been played and view the game. Also note that Able has requested that an email reminder be sent prior to each game.

In line 402 Baker has paid for all (or is otherwise entitled to) all available programs but does not require archiving. Thus, Baker must watch the broadcast live and at the exact time it is being streamed. Note that time delay/conversion 14-4 can be used to move an event to a more convenient time for “live” viewing in different parts of the world. It should also be noted that the sporting events may be organized into leagues and a user may contract for selectively receiving, over the Internet, events from at least one of the leagues. The user may send from time to time an instruction over the Internet that specifies what specific event the contracting user desires to watch in real time.

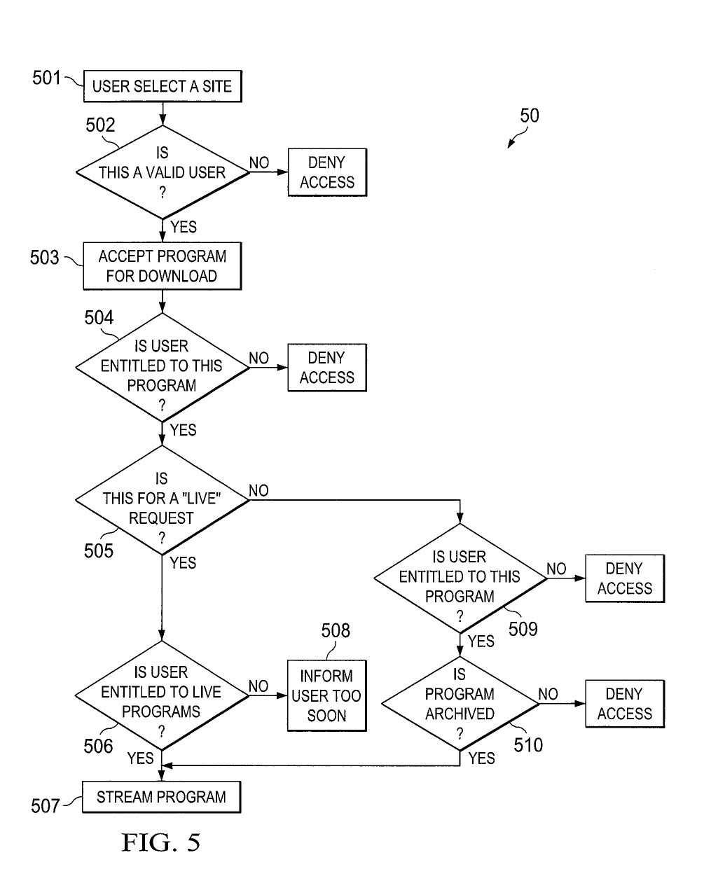

FIG. 5 shows one embodiment 50 of a method of operation of the systems disclosed herein. Process 501 accepts a request from a particular user for access to a particular site, such as to site 14, FIG. 1. Note that the same user could have accessed any one of a plurality of other sites, such as site 18, which can have the same (or some of the same) video or different video entirely. Thus, site 14 might be devoted to sports while site 18 could be, for example, live concerts from anywhere in the world. However, different sites could have some, but not all, sports. In some situations a particular user might be able to watch the Cowboys on different sites each with different announcers or other amenities.

Process 502 determines in the well-known manner whether this particular user is a valid user. This might be time sensitive such that some users can only gain access at certain times. If the user is validated, then process 503 accepts from the user the desired program or programs desired to be watched. Process 504 then determines, with the aide, for example, of database 40, if the user is entitled to view the desired program. Again this may be time sensitive.

If the viewer has the proper permissions, then process 505 determines if this is for a program that will be viewed live. In this context, “live” means substantially as the originally captured action is occurring. If this is a live viewing and if the user is entitled to live viewing, then process 507 controls the delivery of the selected program to this user. However, if this user is not entitled to live viewing (for example, user Eagle, line 405, FIG. 4) then process 508 informs the user that it is too soon to view the selected program.

If the requested program is not a live program then process 509 determines if the user is entitled to view an archived program. If so, then process 510 determines if the program is, in fact, archived in memory. If so, then process 507 streams the selected archived program to the user.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A system for distributing a video program concurrently to a plurality of users via a public network, said system comprising:
at least one video program compression device arranged to accept an HD source video program and to compress said HD source video program so that said compressed HD source video program consumes a low bit rate, said HD source video program having a high bit rate, said compression being such that when said video program is decompressed and viewed by a user it is perceived by a viewer as a high fidelity representation of said source video program; and
at least one addressing device for attaching a network address of a particular user to said video program.

2. The system of claim 1 wherein said low bit rate is below 3 MBits/sec and said high bit rate exceeds 9 MBits/sec.

3. The system of claim 1 wherein said source video program comprises video of events selected from the list consisting of: sporting events, concerts, musical events, plays, movies, news.

4. The system of claim 1 wherein said compression occurs at any of the list consisting of: a camera capturing said source video programs, a server remote from said camera capturing said video programs.

5. A method of selectively delivering high quality video programs individually to requesting users, said method comprising:
accepting, over a data network from a plurality of users, requests for particular ones of said high quality video programs, each said request identifying a specific video program deliverable to an associated specific network address; and
delivering said identified specific video program over said data network to said associated specific network address at a bit rate at or below 0.0482 bits/pixel

6. The method of claim 35 wherein said high quality video programs require a bit rate of at least 10 MBits/sec at a source of said video program.

7. The method of claim 5 wherein said delivering comprises:
compressing said high quality video programs so that each compressed high quality video program consumes a bit rate lower than 3 MBits/sec, said compression being such that when a particular video program is decompressed and viewed by a user it is perceived by said user as a high fidelity representation of said video program source.

8. The method of claim 5 wherein said high quality video programs are live sporting events organized into leagues and wherein a user may contract with an entity for selectively receiving, under control of said entity over said network, events from at least one of said leagues, said selectively receiving comprising:
receiving from a contracting user from time to time an instruction over said network to said entity instructing said entity as to what specific event said contracting user desires to watch in real time; and
under at least partial control of said entity causing said specific event to be sent in real time to a network address specified by said contracting user at a time when said specific event occurs.

9. The method of claim 5 wherein said high quality video programs are live sporting events organized into leagues and wherein a user may contract with an entity for selectively receiving under control of said entity over said network events from at least one of said leagues, said selectively receiving comprising:
receiving from a contracting user from time to time an instruction over said network to said entity instructing said entity as to what specific event said contracting user desires to watch subsequent to a time when said event occurs in real time; and
under at least partial control of said entity causing said specific event to be archived for subsequent delivery to said contracting user.

10. The method of claim 9 further comprising:
sending a specific archived event to a network address specified by said contracting user at a time identified in an instruction received by said contracting user.

11. A method of delivering to a user high quality videos of an event captured by a plurality of cameras, said method comprising:
accepting, over a data network, a request for delivering said high quality videos, wherein said request specifies which of said plurality of cameras should be the source feed of said high quality videos delivered to said user; and
delivering, via said data network, said high quality videos to said user based on said specification of which of said cameras should be a source feed, said delivering occurring at a bit rate of approximately 0.0482 bits/pixel.

12. The method of claim 11 wherein said delivering comprises compressing video captured by said plurality of cameras from 10 MBits/sec and above to 3 MBits/sec or below.

13. The method of claim 12 wherein said compressing is performed by said cameras.

14. The method of claim 12 wherein said compressing is performed by a server remote from said cameras.

15. The method of claim 12 wherein said compressing comprises:
compressing at said cameras and subsequently compressing by a server remote from said cameras.

16. The method of claim 12 wherein said delivering further comprises decompressing said compressed video from 3 MBits/sec to 10 MBits/sec or higher.

17. The method of claim 16 wherein said decompressing is performed by a device connected to a user's viewing screen.

18. The method of claim 11 wherein said request comprises a specification for delivery of more than one source feed.

19. The method of claim 11 wherein said data network is the Internet.

20. The method of claim 11 wherein said high quality video delivered to said user is unedited from at least one of said cameras.

21. A set top box for decompressing video for a user device, said set top box comprising:
a receiver for receiving a high quality video compressed to at least 3 MBits/sec
a decompressor for decompressing said compressed video to approximately 10 MBits/sec and wherein said decompressed video is perceived by a viewer as a high fidelity representation of said source video program; and
a controller for controlling how said decompressed high quality video is displayed on said user device.

22. The set top box of claim 21 wherein said receiver is configured to receive and decompress, concurrently, a plurality of video feeds from different cameras capturing an event.

23. The set top box of claim 22 wherein said controller is configured to control concurrent display of said plurality of video feeds as a function of instructions from a user.

24. The set top box of claim 23 wherein said instructions from said user are delivered from a device operable by a user, said device remote from said set top box.

25. The set top box of claim 21 wherein said user device is selected from the list consisting of: a personal computer, a television, a clicker.

26. A remote device for controlling a set top box, said device comprising:
a set top box capable of decompressing video received via an Internet connection; and
a key pad remote from set top box for navigating said Internet to select a video file being communicated to said set top box over said Internet at a compressed bit rate below 0.0482 bits/pixel, and,
a decompressor for rendering from a selected compressed video bit rate a high fidelity video image representation of a source video file.

27. The remote device of claim 26 wherein said compression is at or under 3 MBits/sec.

28. The remote device of claim 27 wherein said key pad is further capable of being used to control how camera feeds are displayed on said user device.

29. The remote device of claim 27 wherein said compression is at or above 1.5 MBits/sec.

30. The remote device of claim 26 wherein said compressed bit rate is at or above 0.024 bits/pixel.

31. The system of claim 2 wherein said high fidelity resolution comprises a resolution of 1080i.

32. The system of claim 1 wherein said low bit rate is 1.5 Mbps.

33. The system of claim 32 wherein said high fidelity resolution comprises a resolution of 1080i.

34. The system of claim 1 wherein said high fidelity resolution comprises a bit rate of less than 0.0482 bits/pixel.

35. The system of claim 1 wherein said high fidelity resolution comprises a bit rate between 0.0482 bits/pixel and 0.024 bits/pixel.

36. The method of claim 5 wherein said bit rate is at or greater than 0.024 bits/pixel.

37. The method of claim 11 wherein said bit rate is below 0.0482 bits/pixel.

38. The method of claim 37 wherein said bit rate is at or above 0.024 bits/pixel.

39. The set top box of claim 21 wherein said video is compressed to 1.5 MBits/sec or above.
